(19) United States
(12) Patent Application Publication
(10) Pub. No.: US 2010/0169460 A1
(43) Pub. Date: Jul. 1, 2010

(54) Methods and Apparatus for Distributing Electronic Media Content for the Purpose of Enhancing Existing Media

(76) Inventors: Robert Charles Angell, West Greenwich, RI (US); Ian Mitchell, Newport County, RI (US)

Correspondence Address: RYAN, MASON & LEWIS, LLP, 1300 POST ROAD, SUITE 205, FAIRFIELD, CT, 06824, US

(21) Appl. No.: 12/532,964

(22) PCT Filed: Mar. 28, 2008
(86) PCT No.: PCT/US08/58558

§ 371 Date: Feb. 19, 2010

Related U.S. Application Data
(60) Provisional application No. 60/909,130, filed on Mar. 30, 2007.

(51) Int. Cl. G06F 15/16

(52) U.S. Cl. 709/219; 709/231

(57) ABSTRACT

Methods and apparatus are provided for distributing electronic media content for the purpose of enhancing existing media. A Media Enhancement Distribution System is disclosed that allows users to download secondary media content, such as trivial pursuit type interaction, games or additional information, from the Internet in order to get additional entertainment or entertainment value that is related to the user's existing media or content. The downloaded content and services could be associated to a specific DVD, a group of DVD, or any DVD. The exemplary Media Enhancement Distribution System is an Internet-based system that provides a mechanism and a process for consumers to specify, access, and download Secondary Media content to be used in conjunction with their existing electronic media (Primary Media). Further, the disclosed system allows content authors to update the downloadable Secondary Media and to provide additional downloadable Secondary Media and to specify the consumer Primary Media to which it can be applied.

### CROSS-REFERENCE TO RELATED APPLICATIONS

This application claims the benefit of U.S. Provisional Application No. 60/909,130, filed Mar. 30, 2007, and is related to United States Provisional Patent Applications entitled “Methods and Apparatus for Combining Media from Multiple Sources for Display and Viewer Interaction” and “Methods and Apparatus for Simplifying the Creation and Editing of Media Intended for the Enhancement of Consumer Media,” each incorporated by reference herein.

### FIELD OF THE INVENTION

The present invention relates to the storage, process, and electronic distribution of media content for the purpose of combining the media with other related and pre-existing media content.

### BACKGROUND OF THE INVENTION

There are an ever-increasing number of sources and types of electronic media as various technologies advance. Types of electronic media include, but are not limited to, text, image, animations, movies of various formats, games and interactive applications. Sources of electronic media include optically recorded media (such as CD, DVD, HD DVD and Blue-Ray), the Internet, magnetic storage devices and electronic storage devices. A need exists for an Internet-based service that allows a user to access additional media (Secondary Media) to be used in conjunction with their existing media (Primary Media) using appropriate display and processing technologies.

### SUMMARY OF THE INVENTION

Generally, methods and apparatus are provided for distributing electronic media content for the purpose of enhancing existing media. A service and operational environment is disclosed that allows users to download media content from the Internet in order to get additional entertainment or entertainment value that is related to the consumer's DVDs. For the purposes of this presentation, this system will be identified as MEDS (Media Enhancement Distribution System). The additional value of MEDS includes services and content related to trivial pursuit type interaction, games and information, that could be displayed with or otherwise associated with a consumer's DVD. The services could also include things like contents, high scores, communities and chat. There are numerous consumer subscription models that could be applied including based on time period or per DVD. The downloaded content and services could be associated to a specific DVD, a group of DVD, or any DVD. This technology could also be applied to other content that the consumer may have including other formats of optical storage devices.

According to one aspect of the invention, MEDS is an Internet-based system that provides a mechanism and a process for consumers to specify, access, and download Secondary Media content to be used in conjunction with their existing electronic media (Primary Media). The system stores Secondary Media that is associated with a particular Primary Media such as a single and specific DVD, a DVD series, DVD genres, or any DVD. In this case, DVD formatted content is for illustrative purposes, the intent of this invention is to provide additional content for consumer's media of various formats and stored on a variety of devices. The Secondary Media that is stored in the MEDS database is accessed via the Internet by consumers or automatically by available participating technology or devices. Further, the system allows content authors to update the downloadable Secondary Media and to provide additional downloadable Secondary Media and to specify the consumer Primary Media to which it can be applied. The system will allow account-based access by consumers to establish and purchase Secondary Media for downloadable for that account. The system will distribute Secondary Media based on consumer account information and consumer Primary Media information that is supplied during the download process.

Among other benefits, the present invention enhances media that a user may purchase or has previously purchased. Further, these enhancements can be updated or augmented by the content provider and obtained by the consumers. The media can be downloaded and stored locally by the consumer or downloaded (e.g., in real time). In this manner, content providers can give consumers added value to their media in the form of games, applications, amplifying information and on-line communities. It will also allow content providers to offer additional marketing-related information to consumers.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of the Media Enhancement Distribution System in accordance with an embodiment of the present invention;

FIG. 2 is a flow diagram representing the Media Author interaction with the MEDS;

FIGS. 3A and 3B are flow diagrams representing the Consumer interactions with the MEDS; and

FIG. 4 is a sample table from an exemplary multi-media overlay index incorporating features of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

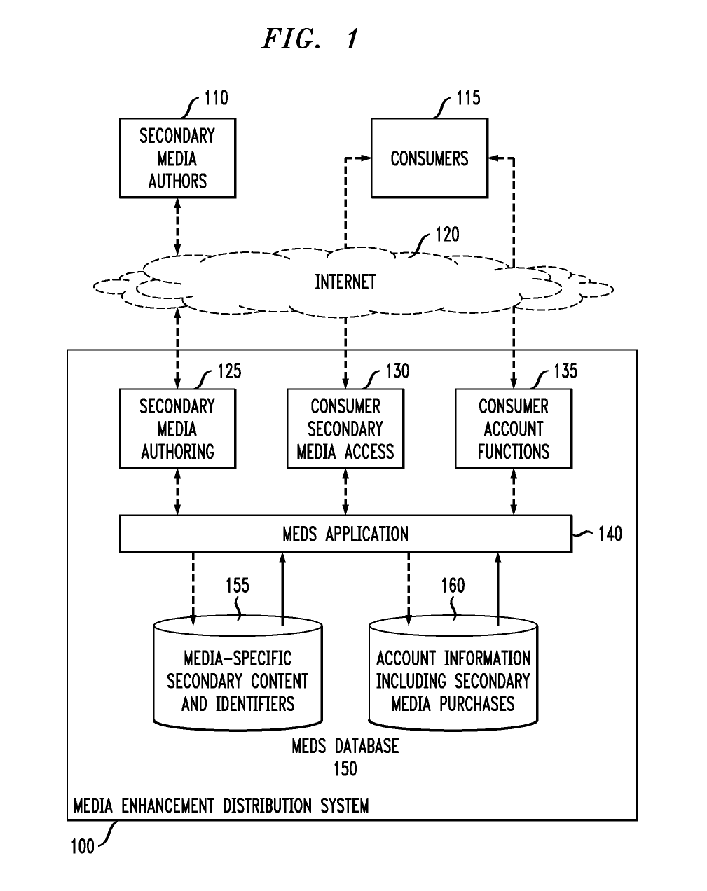

FIG. 1 is a block diagram of an exemplary embodiment of the Media Enhancement Distribution System 100 in accordance with an embodiment of the present invention. As shown in FIG. 1, an exemplary Media Enhancement Distribution System 100 comprises the MEDS web server 140, an interface 125 for Secondary Media Authors 110 that create Secondary Media to be associated with Primary Media, and interfaces 130, 135 for Consumers 115 to download Secondary Media for use with their Primary Media and to create MEDS accounts, respectively.

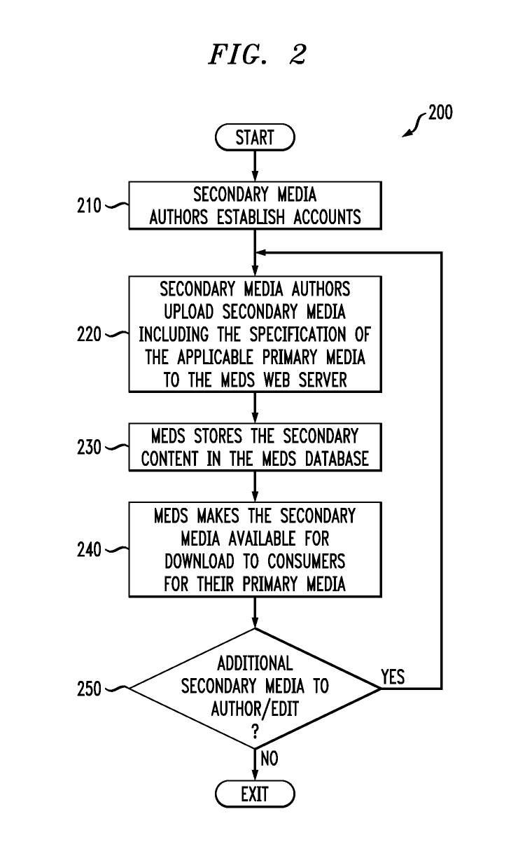

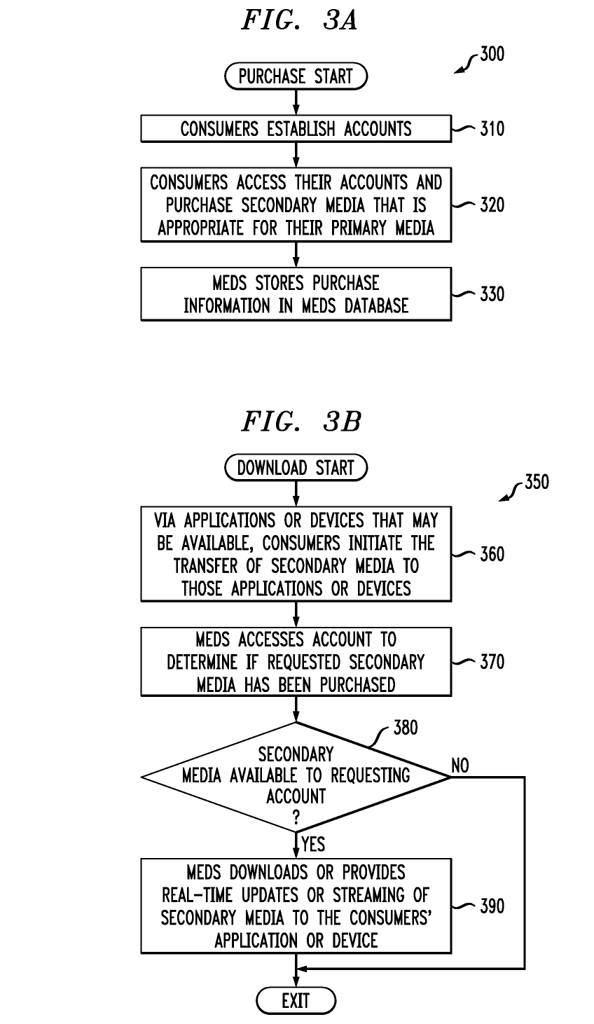

FIG. 1 shows the interaction between the Authors 110 and the MEDS web server 140 and the interaction between the Consumers 115 and the MEDS web server 140, in a manner discussed further below in conjunction with FIGS. 2 and 3. FIG. 1 also shows the main application of the MEDS web server that handles Secondary Media upload from Authors 125, Secondary Content download to Consumers 130, and account creation and access by Consumers 135. In addition, FIG. 1 shows the databases 150. The databases 150 comprise a first database 155 that contains the Authored Secondary Media and identifiers that indicate what Primary Media can be associated with that Secondary Media. A second database 160 contains consumer account information and purchases.

FIG. 2 is a flow diagram 200 representing exemplary Media Author interactions with the MEDS. FIG. 2 depicts the method of operation of an exemplary implementation of the disclosed MEDS relative to the interaction of Secondary Media Authors with the system. Authors first create an account during step 210 that will allow the upload of Secondary Media. Once an Author has created Secondary Media, it may be uploaded during step 220 to the MEDS web server 140. Information pertaining to what Primary Media can be associated with the Secondary Media is required before the Secondary Media is available for download. A single Author may upload multiple works of Secondary Media. The Secondary Content is stored in the MEDS database during step 230 The MEDS makes the Secondary Media available for download to consumers for their Primary Media during step 240.

A test is performed during step 250 to determine if additional Secondary Media needs to be Authored or edited. Program control then terminates if there is no additional Secondary Media.

FIG. 3A is a flow diagram 300 representing exemplary Consumer interactions with the MEDS for the purchase of secondary content. Consumers first create an account during step 310 that will allow the download of Secondary Media. Once a Consumer has established an account, the Consumer may, for example, go to the web site with a standard web browser during step 320 and specify or purchase Secondary Media that he or she is interested in downloading for use with his or her Primary Media. After specifying the Secondary Media, it may be downloaded by the consumer. The MEDS stores purchase information in MEDS database during step 330.

FIG. 3B is a flow diagram 350 representing exemplary Consumer interactions with the MEDS for the download of purchased secondary content. The download may be done directly by the Consumer, for example, via the web site, via a computer application, via a device that is intended to combine Primary and Secondary Media, or some other technology. The type of download may be a one-time download, real-time streaming or interactive (web site interaction occurs as needed by the downloading technology).

Consumers can initiate the transfer of Secondary Media to the appropriate applications or devices during step 360. The MEDS then accesses the user account during step 370 to determine if the requested Secondary Media has been purchased. If it is determined during step 380 that the Secondary Media is available to the requesting Account, then the MEDS downloads or provides real-time updates or streaming of the Secondary Media to the Consumers' application or device during step 390.

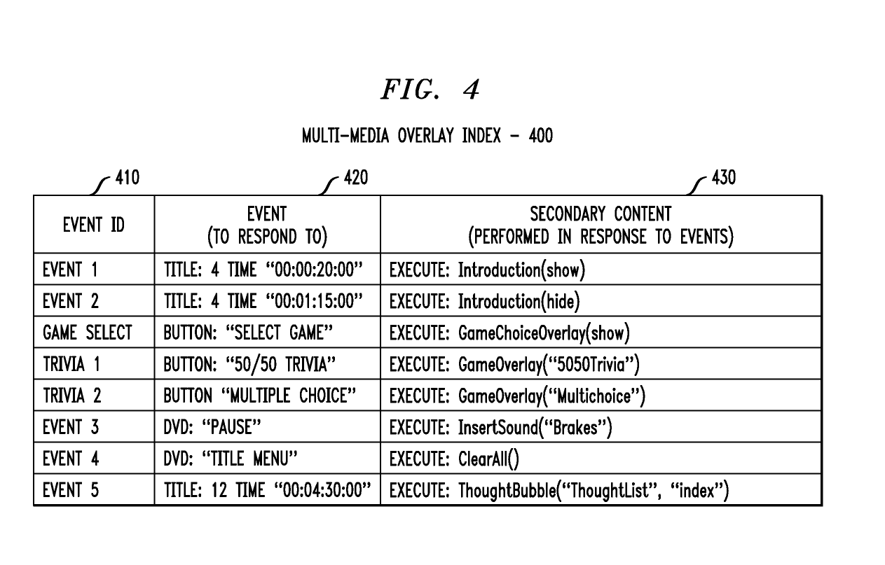

FIG. 4 is a sample table from an exemplary multi-media overlay index 400 incorporating features of the present invention. As shown in FIG. 4, the exemplary multi-media overlay index 400 is associated with a particular primary content item, such as a particular movie or a particular episode of a television show. The exemplary multi-media overlay index 400 comprises a plurality of records, each associated with a different event in the primary content. For each event identified in field 410, the exemplary multi-media overlay index 400 defines the event in the field 420 and identifies the secondary content associated with the event in field 430.

The exemplary multi-media overlay index 400 allows particular secondary content to be associated with desired times or events in the primary content. Examples of secondary content include trivial pursuit type interaction, graphic overlays, additional sound and interactive games.

While FIGS. 2 and 3 show an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A server for distributing supplemental content, comprising:
a memory; and
at least one processor, coupled to the memory, operative to:
obtain supplemental content for distribution to one or more end-users, wherein said supplemental content has an identifier identifying one or more related primary content items and an overlay index that associates said supplemental content with one or more times or events in said primary content items; and
provide said supplemental content to one or more end-users.

2. The server of claim 1, wherein said primary content items are obtained from one or more of a CD, DVD or streaming media connection.

3. The server of claim 1, wherein said supplemental content is presented to said user based on or more of a schedule, a timeline, user control actions and events in said primary content item.

4. The server of claim 1, wherein said supplemental content is presented to said user based on links to said primary content item.

5. The server of claim 1, wherein said supplemental content is overlayed on said primary content item.

6. The server of claim 1, wherein said supplemental content is overlayed on said primary content item by an end-user application.

7. A method for distributing supplemental content, comprising:
obtaining supplemental content for distribution to one or more end-users, wherein said supplemental content has an identifier identifying one or more related primary content items and an overlay index that associates said supplemental content with one or more times or events in said primary content items; and
providing said supplemental content to one or more end-users.

8. The method of claim 7, wherein said primary content items are obtained from one or more of a CD, DVD or streaming media connection.

9. The method of claim 7, wherein said supplemental content is presented to said user based on or more of a schedule, a timeline, user control actions and events in said primary content item.

10. The method of claim 7, wherein said supplemental content is presented to said user based on links to said primary content item.

11. The method of claim 7, wherein said supplemental content is overlayed on said primary content item.

12. The method of claim 7, wherein said supplemental content is overlayed on said primary content item by an end-user application.

13. An article of manufacture for distributing supplemental content, comprising a machine readable storage medium containing one or move programs which when executed implement the steps of:
obtaining supplemental content for distribution to one or more end-users, wherein said supplemental content has an identifier identifying one or more related primary content items and an overlay index that associates said supplemental content with one or more times or events in said primary content items; and
providing said supplemental content to one or more end-users.

14. The article of manufacture of claim 13, wherein said primary content items are obtained from one or more of a CD, DVD or streaming media connection.

15. The article of manufacture of claim 13, wherein said supplemental content is presented to said user based on or more of a schedule, a timeline, user control actions and events in said primary content item.

16. The article of manufacture of claim 13, wherein said supplemental content is presented to said user based on links to said primary content item.

17. The article of manufacture of claim 13, wherein said supplemental content is overlayed on said primary content item.

18. The article of manufacture of claim 13, wherein said supplemental content is overlayed on said primary content item by an end-user application.
